(19) United States
(12) Patent Application Publication
(10) Pub. No.: US 2010/0051119 A1
(43) Pub. Date: Mar. 4, 2010

(54) Pressure relief valve

(76) Inventor: Gregory A. Klein, East Amherst, NY (US)

Correspondence Address: Kenneth J. LuKacher;South Winton Court, Suite 301, 3136 Winton Road South, Rochester, NY, 14623, US

(21) Appl. No.: 12/231,554

(22) Filed: Sep. 4, 2008

(51) Int. Cl. F16K 15/04

(52) U.S. Cl. 137/540

(57) ABSTRACT

A pressure relief valve controls the pressure in a pressure chamber of a sprayer. The pressure chamber is inside a tank from which liquid to be sprayed is pumped into the pressure chamber and pressurized. The pressurized liquid is released from the chamber via a hose and nozzle for spraying. The pressure relief valve has a holder or body with an opening therethrough. A sleeve is movable in the body and contains a compression spring. The spring is compressed against a lower end of the body by a cap which is rotatable about the holder and engages the spring. The sleeve captures a ball providing a valve against a valve seat in the holder. The sleeve constrains the motion of the valve and the spring so that the valve opens at the release pressure corresponding to the compression of the spring by the cap, and the release pressure is the same, even with repeated openings and closings of the valve. Leakage through the valve is also substantially eliminated.

The present invention relates to pressure responsive valves, and particularly to pressure relief valves. A pressure relief valve in accordance with the invention is especially suitable for use in a sprayer having a pressure chamber inside a tank containing liquid to be sprayed, which liquid is pumped into the pressure chamber and compressed so that the liquid may be released via a hose and nozzle for spraying. Such sprayers, including a pressure relief valve of design over which the valve provided by the invention is an improvement are shown in Pagliai et al., U.S. Pat. No. 4,702,416, issued Oct. 27, 1987, which discloses a sprayer in which a valve in accordance with the invention may be used and to which reference may be had for description of details of the sprayer and its pressure chamber.

Pressure relief valves, such as shown in the above referenced patent, determine the release pressure by compression of a spring. However, the release pressure is indeterminate and not repeatable due to the mechanical instability of the spring and the valve which is controlled by the spring. Because of the mechanical instability of the valve, there is varying leakage through the valve in the course of its operation. For example, the pressure range at which the valve releases may vary over a range of 20 psi between 60-80 psi, even though the valve at the time of manufacture or installation was set to open at 60 psi.

Accordingly, it is a feature of the invention to provide a pressure control valve which is especially suitable for controlling the pressure in a pressure chamber and provides improved control of the pressure by relieving the pressure in the chamber at a pressure at which the valve is set to open.

A further feature of the invention provides an improved pressure relief valve, the pressure at which the valve opens is set by the compression of a coil spring, which reduces mechanical instabilities which may cause undesired leakage from the valve and indeterminate pressures at which the valve opens to relieve the pressure in a pressure chamber in which the valve is installed.

Another feature of the invention is to provide an improved pressure relief valve of a design which facilitates assembly of the parts thereof, which includes a coil spring, a spring compression cap, a valve element, a sleeve member for retaining the spring and the valve element, a holder for the sleeve upon which the cap is rotatable in which the holder providing a seat for the movable valve element of the assembly.

Briefly described, an improved pressure responsive valve, in accordance with the invention, utilizes a coil spring, the compression of which is by a cap, which is movable in a holder, determines the opening of a valve in response to pressure applied thereto which further compresses the spring to enable the valve to open. A sleeve is movable along an opening in the holder. The sleeve constrains and aligns the spring and a valve, which is preferably a ball valve, inside the holder. The sleeve assures that the valve and the spring are mechanically stable and remain in alignment with the valve seat for different compressions of the spring thereby making the pressure applied to the valve at which it opens repeatedly determinable, and wherein leakage through the valve is avoided.

The foregoing features and other objects and advantages of the invention will become more apparent through a reading of the following description in connection with the accompanying drawings in which:

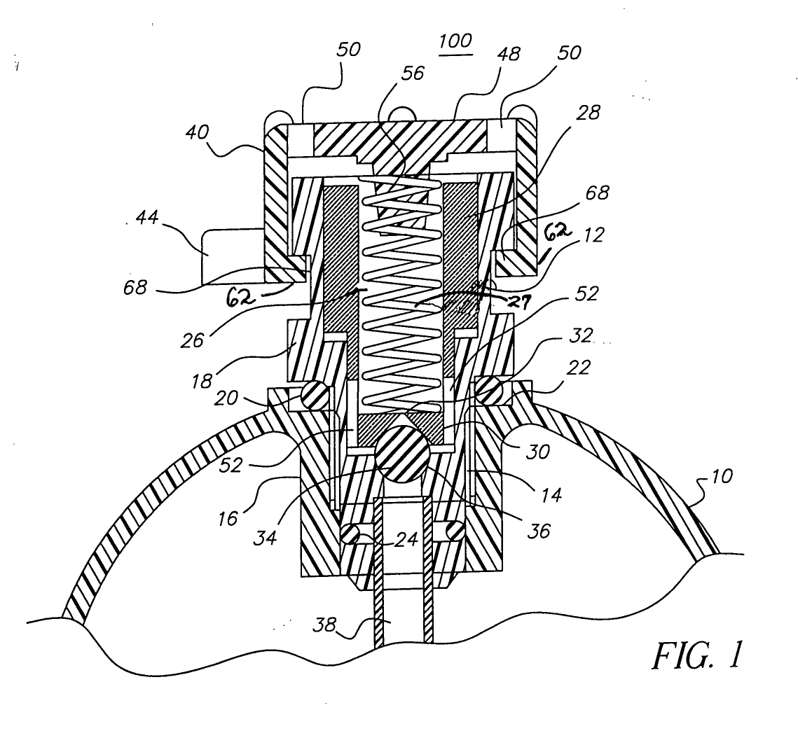

FIG. 1 is a sectional view through a portion of the pressure chamber at the top thereof showing a pressure relief valve assembled to the pressure chamber and a tube for presenting pressurized liquid in the chamber to the valve;

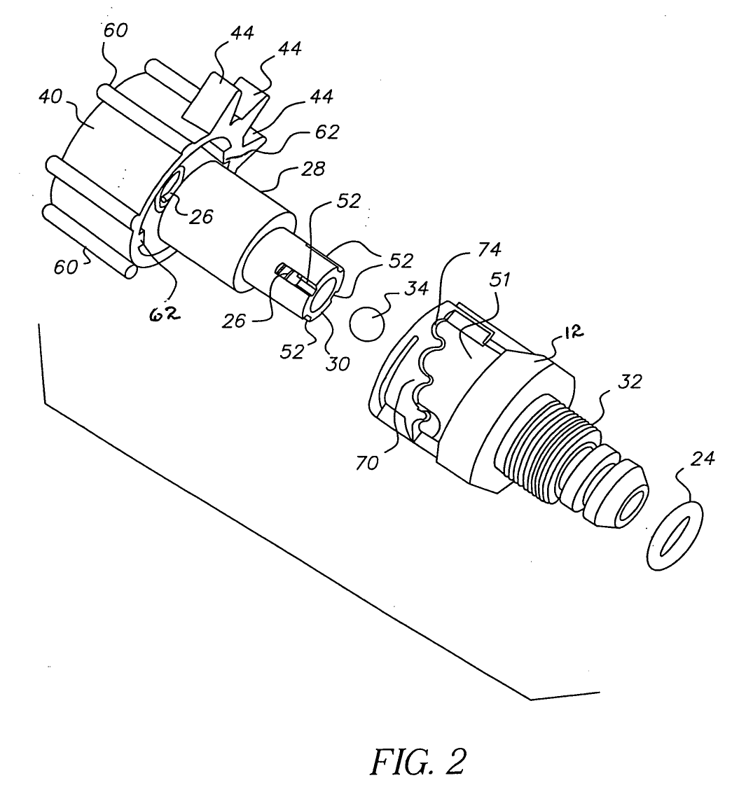

FIG. 2 is a perspective exploded view of the principal components of the pressure relief valve shown in FIG. 1;

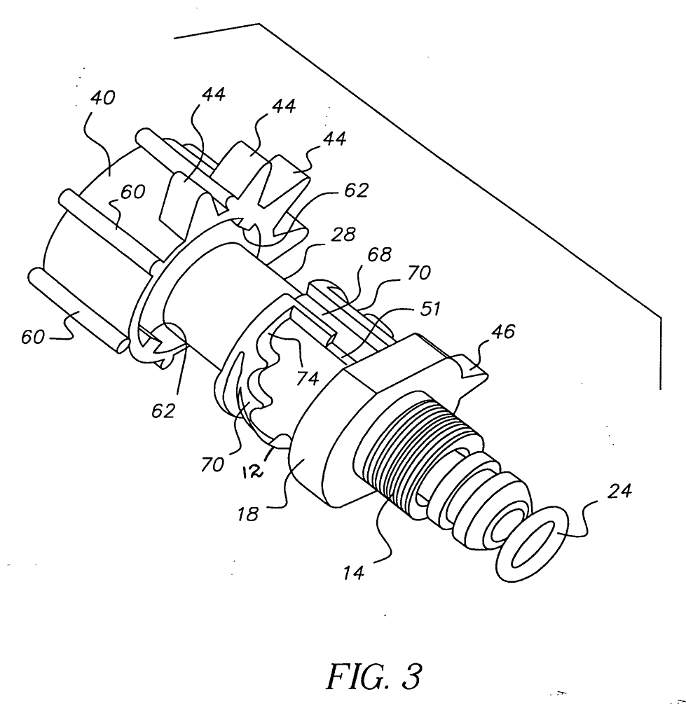

FIG. 3 is a perspective view illustrating the pressure relief valve with the components viewed from an angle different from that shown in FIG. 2; and

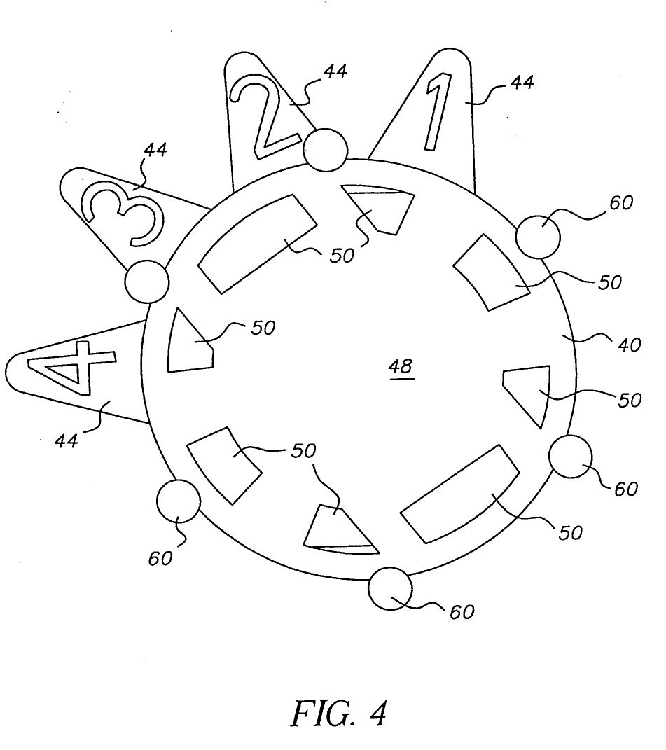

FIG. 4 is a top view of the pressure relief valve shown in FIG. 1.

Referring to the drawings, there is shown a portion of a pressure chamber 10 containing pressurized liquid which may be used in a sprayer of the type illustrated in the above referenced U.S. Patent. A pressure relief valve 100 is mounted to the chamber 10. The pressure relief valve 100 has a body or holder 12, which is threaded at 14, into an introverted tube 16 inside the chamber 10. A lip 18 on the holder compresses an O-ring 20 against a shoulder 22 presented by the introverted tube 16 at the top thereof. Another O-ring 24 around the lower end of the holder together with the O-ring 20 provides a pressure tight seal for the holder 12 in the pressure chamber 10.

A step passageway 26 provides tubular openings of different diameter through the holder 12.

A sleeve 28 is movable axially of the holder in the opening 26. This sleeve 28 has a lower end in the form of a disk 30 with a conically tapered notch 32. A ball valve 34 is constrained between the sleeve 28 at the disk 32 providing an end of the sleeve 28, and a valve seat 36 in the holder which has a surface providing a segment of a cone corresponding to the spherical surface of the ball valve 34. The ball valve 34 is exposed to the pressure of the liquid in the chamber 10 via a tube 38 which extends into the liquid in communication with an opening in passageway 26 provided through valve seat 36. This opening being normally occluded by ball valve 34 in non-pressure relief conditions in chamber 10. Further details as to the length and operation of the tube in supplying pressurized liquid to the pressure relief valve 100 may be found by reference to the above referenced Pagliai et al. patent.

A cap 40 is movable axially to compress the spring for different compressions at four different steps in the rotation of the valve. These compressions may correspond to pressure relief settings of 15, 30, 45, and 60 psi respectively. Indicating pointers 44 can be aligned with a pointer 46 extending from the holder 12 (see FIG. 3). The pointers 44 are marked 1, 2, 3, and 4 in FIG. 4, and when aligned with the pointer 46, provide the four different pressure relief settings of the valve. The top of the cap 40 is closed by a disk 48 and has a plurality of circumferentially spaced openings 50 through which fluid passes through the pressure relief valve when the ball valve 34 opens.

The path for fluid is through the tube 38 and past the space between the seat 38 and the surface of the ball valve 34 when open. This path continues through slots 52 in the sleeve 28 (two of which are shown in FIG. 1 and more of which are shown in FIG. 2). The fluid then passes along the inside of the sleeve and through the turns of the coil of the spring and out through the cap via the openings 50 therein. The fluid may flow back into the tank of the sprayer as discussed in the above referenced Pagliai et al. patent.

A stub 56 extends downward from the disk 48 of the cap 40, and is captured in a plurality of turns at the top of the spring 27. Further details of the cap 40 are illustrated in FIGS. 2, 3, and 4. The outer periphery of the cap 40 has, in addition to the pointers 44, a plurality of generally circular ribs 60 which enable the cap to be grasped by the fingers of the operator and turned. The cap 40 has, extending from its inner periphery at the bottom thereof a pair of diametrically opposite tabs 62. There are longitudinal slots 68 in the holder 28. There are cams 70 presenting a ratchet surface in which the tabs 68 are captured, as the cap 40 is rotated.

In assembly of the valve, the tabs 62 are pushed down the slot 68, compressing the spring 27. The cap 40 is turned so that the tabs 62 can pass through lateral slots 51. When the cap 40 is released, the tabs 62 move upwardly until stopped by the top surface 74 of the ratchets 70. To increase the tension (or bias) in the spring, the cap is turned with the aid of the ribs 60. The ratchet 70 presents four steps corresponding to the four pointers 44. These steps are reached when the pointer for the desired compression and selected release pressure is in alignment with the pointer 46 on the holder 28. In operation for pressure relief, when the pressure in chamber 10 exceeds that by desired by the user selection of one of the release pressure settings, the valve element 34 moves away from the valve seat 36 and then move back upon the valve seat 36 when the condition in chamber 10 is relieved.

The materials of the valve may be as follows: The O-rings 20 and 24 may be rubber. The holder 28 and the cap 40 may be plastic, such as a high-density polyethylene of which the pressure chamber 10 is constructed. Other plastics, such as polycarbonate may also be used. The sleeve 28 may be plastic or metal (e.g., copper or brass). The spring 27 is a metal coil spring of steel or brass. The valve 34 is a soft, compressible plastic, such as polyethylene.

The diameter of the spring 27 is approximately the same as the inner diameter of the opening 26 of sleeve 28. Thus, the spring is aligned and is mechanically stable because it is constrained by the sleeve. The movable sleeve 28 also constrains the ball valve 34 and aligns it with the valve seat 36. Accordingly, all the movable parts are constrained and alignment of the spring 27 and the valve 34 with the seat 36 is maintained throughout the operation and at the various compression/pressure settings of the valve 100. Leakage of fluid is avoided, and repeatability of operations such that the pressure in the pressure chamber is controlled for providing desired spraying pressure and for safety (burst strength) considerations.

Variations and modifications in the herein described valve, within the scope of the invention will undoubtedly suggest themselves to those skilled in the art. Accordingly, the forgoing description should be taken as illustrative and not in a limiting sense.

1. A pressure responsive valve in which the compressibility of a coil spring sets the pressure in response to which valve opened, said valve comprising a sleeve movable in a direction along which pressure is applied to the valve, said coil spring being disposed inside said sleeve.

2. The valve according to claim 1 further comprising a pressurizable chamber in which said pressure responsive valve is disposed and which provides the pressure to which said valve responds by opening to release when the pressure which said spring set is provided in said chamber.

3. The valve according to claim 1 further comprising a holder in which said sleeve is movable, a seat for said valve in said holder, said sleeve having an end and outside of which faces said seat and presents said valve thereto, said end having an inside against which said spring bears at one end of said spring.

4. The valve according to claim 3 wherein said valve is a ball which is captured between a surface of said seat and a surface of said outside of said end of said sleeve.

5. The valve according to claim 4 wherein said ball is spherical and said surface of said seat corresponds to said spherical surface of said ball, except for an opening through said holder via which pressure is applied to said valve, and said out side of said holder defines a disk having a tapered opening in which that ball is disposed.

6. The valve according to claim 4 wherein said spring has a diameter not exceeding the inside diameter of said sleeve.

7. The valve according to claim 6 wherein said coil substantially fills the inside diameter of said sleeve, both radially and axially thereof.

8. The valve according to claim 7 wherein said spring is approximately the same diameter as the inside diameter of said sleeve and approximately the same length as said sleeve, thereby substantially filling the inside diameter of said sleeve.

9. The valve according to claim 3 further comprising a cap on and movable axially of said holder, said cap engaging said spring at an end there opposite to said one end for changing the compression of said spring and the pressure in response to which said valve opens.

10. The valve according to claim 8 wherein said holder has an outside surface defining a ratchet having a plurality of steps between which said cap is movable, said steps corresponding to different pressures at which said valve opens.

11. The valve according to claim 3 wherein said sleeve has at least one slot extending axially from said outside end and providing a path for pressurized liquid released by said valve upon opening thereof axially along the inside of said sleeve and through the coils of said spring.

12. A pressure relief valve to a pressure chamber comprising:
a spring;
a member into which the spring is received;
a valve element, and a fixed valve seat having an opening in communication with the pressure chamber, in which said valve element is disposed between said member and said valve seat to normally occlude said opening; and
means for selecting one of a plurality of levels of bias of said spring against said valve element upon said valve seat to provide different settings to release pressure from the chamber via said opening by movement of said biased valve element away from said opening in accordance with different ones of said plurality of levels of bias of said spring against said valve element, in which said member maintains the alignment of the spring with respect to the valve seat at each of said plurality of different levels of bias of said spring upon said valve element.
